(19) United States
(12) Patent Application Publication
(10) Pub. No.: US 2026/0247302 A1
(43) Pub. Date: Aug. 20, 2026

(54) BATTERY OPTIMIZATION FOR UNMANNED AERIAL VEHICLES OVER MULTI-CARRIER TERRESTRIAL 5G NETWORKS

(71) Applicants: AT&T Intellectual Property I, L.P., Atlanta, GA (US); AT&T Technical Services Company, Inc., Vienna, VA (US)

(72) Inventors: Daniel Vivanco, Ashburn, VA (US); Yupeng Jia, South Pasadena, CA (US)

(73) Assignees: AT&T Intellectual Property I, L.P., Atlanta, GA (US); AT&T Technical Services Company, Inc., Vienna, VA (US)

(21) Appl. No.: 19/057,004

(22) Filed: Feb. 19, 2025

(51) Int. Cl. H04W 52/32; H04B 7/185; H04W 52/02; H04W 52/14

(52) U.S. Cl. CPC H04W 52/325; H04B 7/18506; H04W 52/0277; H04W 52/146

(57) ABSTRACT

Aspects of the subject disclosure may include, for example, receiving information about radio communication by an aerial user equipment operating in conjunction with terrestrial radio networks, the radio communication including transmitting by radio circuitry of the aerial user equipment to remote receivers on respective uplinks, receiving information about uplink traffic demand on the respective uplinks, receiving information about a remaining battery capacity of a battery system which powers the aerial user equipment, determining, based on the uplink traffic demand and the remaining battery capacity of the battery system, adjustments to transmit power on the respective uplinks, the adjustments to optimize power consumption from the battery system in order to extend operational time for the aerial user equipment, and communicating, to the aerial user equipment, information about the adjustments to cause the radio circuitry of the aerial user equipment to reduce power consumption to extend the operational time for the aerial user equipment. Other embodiments are disclosed.

### FIELD OF THE DISCLOSURE

The subject disclosure relates to a method and apparatus for optimizing battery usage in devices such as unmanned aerial vehicles (UAVs) when airborne over terrestrial cellular networks.

### BACKGROUND

Operators of wireless networks provide communication services to a variety of customers and user equipment (UE). Some UEs include aerial UEs or unmanned aerial vehicles (UAV) which may in some instances conventionally be called drones. The UAV or aerial UE is generally powered by an onboard battery. The battery is a depletable energy source that powers both electric motors for lift and propulsion and radio circuits for communication. Energy storage in a battery thus becomes an important resource to manage.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for optimizing battery usage in unmanned aerial vehicles (UAVs) operating over multi-carrier terrestrial 5G networks by dynamically managing data and uplink power control based on factors such as UAV traffic requirements, battery levels, and power consumption predictions. A system and method may utilize 3GPP-defined uplink power control mechanisms to adjust transmission power according to factors such as distance and bandwidth needs, thereby conserving battery life in the battery that powers the UAV. The system introduces an algorithm that monitors real-time battery levels and employs prediction models to anticipate battery drainage, allowing for necessary adjustments to extend UAV operational time. Other embodiments are described in the subject disclosure.

One or more aspects of the subject disclosure include receiving, from an unmanned aerial vehicle (UAV) including radio communication circuitry and powered by a battery, battery charge information indicative of a remaining charge in the battery, receiving information about radio communication by the radio communication circuitry, including receiving information about current uplink transmission demand by the radio communication circuitry with one or more terrestrial communication networks, contrasting traffic requirements for the radio communication and the remaining charge in the battery to evaluate a likelihood of exhaustion of the battery, recommending actions to optimize power consumption from the battery in order to extend operational time for the UAV, and communicating, to the UAV over a terrestrial communication network, information to control the power consumption from the battery to reduce the likelihood of exhaustion of the battery.

One or more aspects of the subject disclosure include receiving information about radio communication by an aerial user equipment operating in conjunction with one or more terrestrial radio networks, the radio communication including transmitting by radio circuitry of the aerial user equipment to one or more remote receivers on one or more respective uplinks, receiving information about uplink traffic demand on the one or more respective uplinks, receiving information about a remaining battery capacity of a battery system which powers the aerial user equipment, determining, based on the uplink traffic demand and the remaining battery capacity of the battery system, adjustments to transmit power on the one or more respective uplinks, the adjustments to optimize power consumption from the battery system in order to extend operational time for the aerial user equipment, and communicating, to the aerial user equipment, information about the adjustments to cause the radio circuitry of the aerial user equipment to reduce power consumption to extend the operational time for the aerial user equipment.

One or more aspects of the subject disclosure include adjusting transmit power of one or more transmit paths in an aerial user equipment (UE), wherein the adjusting is based on uplink power control commands received at the aerial UE according to standardized uplink power control procedures for user equipment operating in conjunction with a terrestrial communication network, determining a current battery charge level of a battery system, the battery system providing operating power to the aerial UE, reporting, by the processing system, the current battery charge level to network equipment, wherein the reporting comprises transmitting information about the current battery charge level over an uplink for the network equipment, and receiving power control adjustment information defining uplink power control adjustments to the transmit power of the one or more transmit paths of the aerial UE to reduce power consumption from the battery system of the UE to extend an operational time for the aerial user equipment.

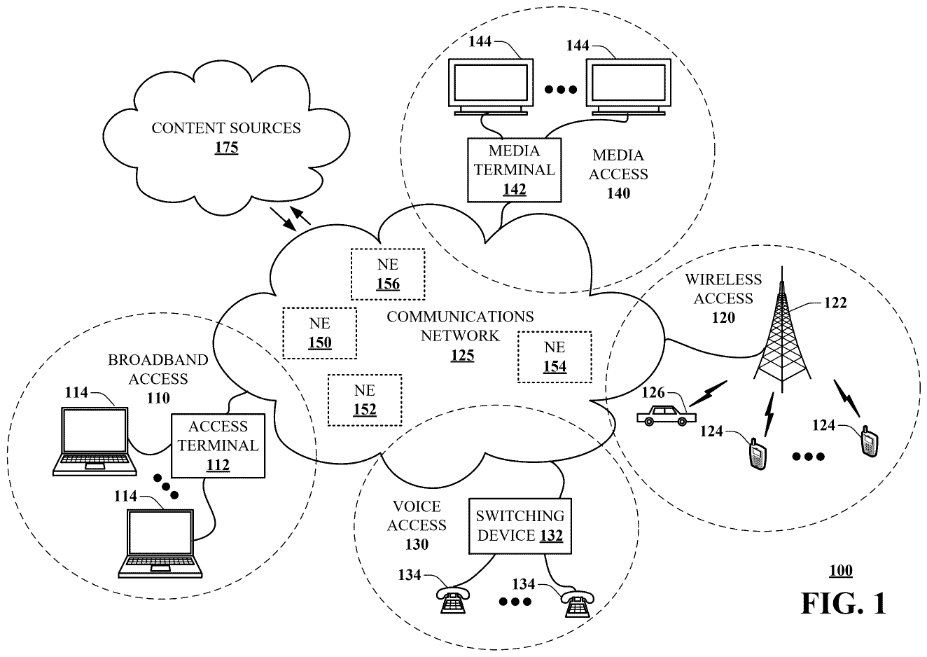

Referring now to FIG. 1, a block diagram is shown illustrating an example, non-limiting embodiment of a system 100 in accordance with various aspects described herein. For example, system 100 can facilitate in whole or in part optimizing battery usage in unmanned aerial vehicles (UAVs) operating over multi-carrier terrestrial 5G networks by dynamically managing data and uplink power control based on factors such as UAV traffic requirements, battery levels, and power consumption predictions. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

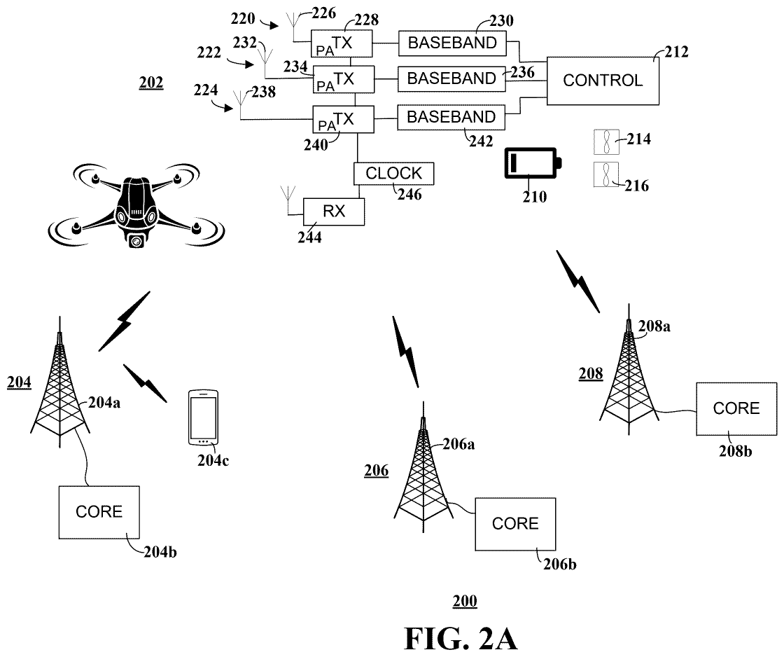

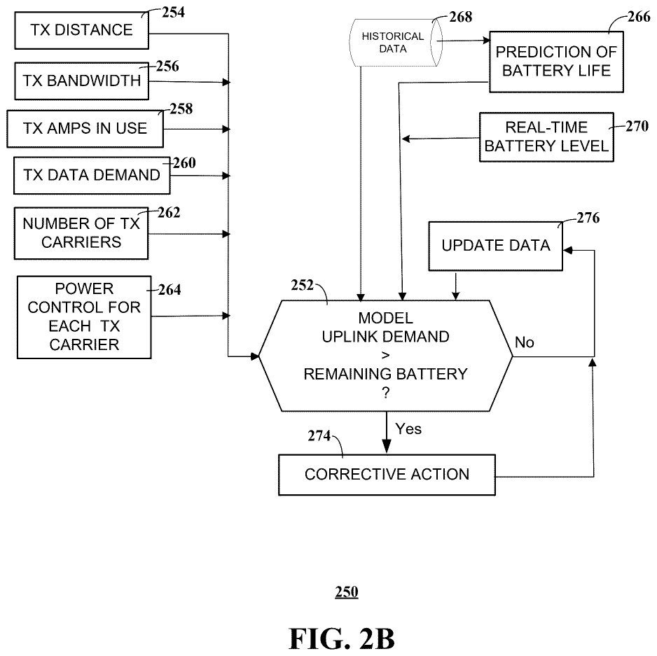

FIG. 2A is a block diagram illustrating an example, non-limiting embodiment of a system 200 functioning within the communications network 125 of FIG. 1 in accordance with various aspects described herein. The system 200 includes an unmanned aerial vehicle (UAV) 202 and a plurality of terrestrial mobility networks, including first mobility network 204, second mobility network 206, and third mobility network 208.

The number of mobility networks is intended to be exemplary only. The UAV 202 may be active in an area served by any number of mobility networks. In general, each mobility network is operated by a respective mobile network operator (MNO). Further, each respective mobility network may use the same or different radio communication technology. Thus, in an example, the first mobility network 204 may implement a fourth generation (4G or long-term evolution, LTE) technology, the second mobility network 206 may implement a fifth generation (5G) cellular technology, and the third mobility network 208 may implement a sixth generation (6G) cellular technology. Any suitable technology or combination of technologies may be present in the mobility networks.

In the example, the first mobility network 204 includes a radio access network 204a and a core network 204b. The radio access network or RAN includes a collection of base stations including gNodeB devices or gNBs. Each base station provides radio communications to user equipment (UE or UE devices) such as UE 204c in a service area near the base station. The core network 204b provides network functions for UEs operating in the RAN including, for example, authorization and authentication, mobility and gateway access to other networks such as the public internet.

Similarly, the second mobility network 206 includes a radio access network 206a and a core network 206b, and the third mobility network 208 includes a radio access network 208a and a core network 208b. The mobility networks, and their constituent elements, are intended to be exemplary only. The mobility networks provide radio communication to terrestrial UE devices in the service areas served by the mobility networks.

In addition, the mobility networks may also provide radio communications to aerial UEs, such as UAV 202, that are airborne in airspace above one or more of the mobility networks, including first mobility network 204, second mobility network 206 and third mobility network 208. In embodiments, the base stations of one of the mobility networks may hand off communications with the aerial UEs such as UAV 202 among the base stations of one mobility network, such as first mobility network 204, to provide mobility for the UAV 202 within the service area of one mobility network. In other embodiments, the base stations of multiple mobility networks may hand off radio communications with the UAV 202 to provide full mobility to the UAV 202 among the service areas of the multiple mobility networks.

The UAV 202 may be any suitable drone or aerial device that may fly under its own power and control in selected areas and maintain radio communications with one or more base stations of a mobility network or other ground equipment. The UAV 202 includes a control circuit 212 and a battery 210 to provide power to the UAV 202. The components of the UAV 202 are intended to be exemplary only. Other embodiments will include fewer or additional components or alternative components.

In particular, the UAV 202 includes one or more electric motors including motor 214 and motor 216 to provide lift and propulsion for the UAV 202. The battery 212 represents a depletable energy source that provides electrical power to circuitry of the UAV 202 as well as to the electric motors including motor 214 and motor 216 which provide lift and propulsion for the UAV 202. The battery 210 is depletable but may be recharged or replaced when located on the ground. During operation, the battery 210 is depleted at a variable rate, based on the current drawn by the motor 214, the motor 216 and circuitry of the UAV 202. The battery 210 may be characterized by a state of charge (SOC) which may range from 100% state of charge or fully charged to 0% state of charge or fully depleted. Any other standard or parameter for characterizing a level of battery charge or usable energy stored in the battery 210 may be used.

For radio communication, the UAV 202 includes radio communication circuitry. In the exemplary embodiment, the UAV 202 may communicate on three different networks or channels simultaneously or independently. In the example, the UAV 202 includes a first transmit path 220, a second transmit path 222 and a third transmit path 224. The first transmit path 220 includes antenna 226, first radio frequency transmit front end 228 and first baseband circuitry 230. Similarly, the second transmit path 222 includes antenna 232, second RF transmit front end 234, and second baseband circuitry 236. The third transmit path 224 includes antenna 238, third RF transmit front end 240, third baseband circuitry 242.

For two-way radio communication, the UAV 202 includes receive path 244. The receive path 244 may include suitable circuitry implementing one or more RF receive front ends and one or more baseband circuits. For timing and synchronization, a clock circuit 246 provides necessary clocking signals. For example, RF transmit and receive circuitry may require precision timing for modulation and demodulation of radio signals.

Mobile network operators (MNOs) such as the MNOs associated with the first mobility network 204, the second mobility network 206 and the third mobility network 208, may use terrestrial cellular network (i.e., incorporating 4G or LTE or 5G cellular technology) to provide services to aerial UEs (UAVs) such as UAV 202. Such UAVs may have multiple use cases, including, for example, delivering products from one location to a destination, monitoring activities or locations, etc.

In some applications, such UAVs may travel over areas where there is limited wireless coverage, such as rural areas which may have sparsely located base stations or gNodeBs. In such remote areas, a traditional UE may not be able to reach even the nearest gNodeB with a transmission. Generally, such UEs are limited to a maximum transmit power of 23 dBm or 200 mw.

In the case of UAVs such as UAV 202, however, some UAVs may employ low noise amplifiers (LNAs) or other power amplifiers to amplify the transmit waveform and thus extend the transmission range. As shown in FIG. 2A, each of the first radio frequency transmit front end 228, the second radio frequency transmit front end 234 and the third radio frequency transmit front end 228 includes a power amplifier (PA) to boost transmission power. The transmit power for any power amplifier may be selected to accommodate several requirements including reliable reception by a receiver at the other end of the channel and minimizing interference with other radios in the area.

Moreover. as illustrated in the example of FIG. 2A, some UAVs such as UAV 202 also may be configured with multiple channels for simultaneous radio connections. Thus, UAV 202 includes a first transmit path 220, a second transmit path 222 and a third transmit path 224. Such multiple transmit paths may be used by the UAV 202 to connect simultaneously to various carriers or to make use of certain advanced technologies such as carrier aggregation and dual technology connectivity. Carrier aggregation allows a device such as the UAV 202 to connect to two or more frequency bands or channels simultaneously to increase data rates and network capacity. Dual connectivity allows a device such as the UAV 202 to simultaneously connect to two different base stations or gNodeBs. Further, as shown in the figure, each transmit path may have its own LNA or power amplifier.

UAVs such as the UAV 202 may be able to detect several energy beams from various gNodeBs located in a wide area. In general, some cellular technologies such as 5G employ beamforming at the gNodeB. Beamforming is a signal processing technique that focuses transmission energy of radio waves in a specific direction by adjusting phase and amplitude of multiple antennas. The beamforming process may create unwanted sidelobes that radiate in directions other than the intended direction of the main beam. Some of the sidelobes can be pointing up rather than parallel to the surface. This may enable a UAV to detect cells that are located far from the current location of the UAV. It is possible that UAVs can detect stronger reference received signal power (RSRP) from far away terrestrial cells than from nearby terrestrial cells. Higher RSRP values generally indicate a stronger signal. Terrestrial cells may be configured with different power levels, so high RSRP may come from far away cells with relatively high power setting and no obstruction.

The UAV 22 may attach to the cell associated with the remote gNodeB. To communicate with the more remote gNodeB, the UAV 202 may have to increase transmit power of the PA of, for example, radio frequency transmit front end 228 to reach the remote gNodeB reliably. For example, the remote gNodeB may use closed-loop power control signals to control the transmit power of the UAV 202.

Under the above circumstances, a UAV with amplifiers configured in the transmit (TX) path and able to use multiple carriers situationally, may induce the battery 210 of the UAV 202 to drain quickly. The transmit path of the UAV 202 may require high energy consumption to provide high transmit output power if the UAV 202 is engaged in heavy uplink transfer. For the UAV 202, the uplink corresponds to communication from the UAV 202 to a base station or gNodeB. The downlink corresponds to communication from the gNodeB to the UAV 202. Further, the transmit path of the UAV 202 may require high energy consumption to provide high transmit output power if the serving cell is far away. Energy usage in the UAV 202 is proportional to transmit power. Higher transmit power to drive the RF transmit front end and power amplifier requires greater power and current drain from the battery 210 that powers the UAV 202. Therefore, the UAV 202 will tend to drain its battery 210 relatively more quickly since it will have large path loss to serving cell at the remote gNodeB.

Moreover, the UAV 202 may communicate information for particular applications. Some of these applications may require relatively high bandwidth (BW) and relatively high transmit power to satisfy operational requirements, quality of service requirements, quality of experience requirements, and others. Examples of such applications include uploading high definition (HD) video data on an uplink transmitted by the UAV 202 to a gNodeB including the remote gNodeB. The UAV 202 may include a camera or other sensors to detect the video data or may operate as repeater, receiving data from another device and forwarding the data to the network via a gNodeB of a terrestrial network.

Conventional handheld UEs such as UE 204c require a transmit power of 23 dBm or about 200 mW. Under good circumstances, such as a rural area with few obstructions or interference, a handheld UE such as UE 204c may have a maximum transmission range of 2-5 miles (2.5 to 6 km). A UAV such as UAV 202 may employ a transmit power of 5 to 10 W, given the noted operational circumstances. Such transmit power may correspond to a maximum range of 10 to 20 miles (12-25 km). In addition, the UAV 202 may have more antennas to drive and may communicate simultaneously with a gNodeB on more frequencies or more channels. Still further, given the variety of radio technologies in use, the UAV 202 may communicate using multiple technologies simultaneously, such as 4G, 5G and 6G and others.

Thus, there can be a substantial battery drain on the battery 210 which powers the UAV 202. This drain, as noted, is based on the communication requirements of the radio equipment of the UAV 202. Moreover, the battery 210 must provide operating power to other components of the UAV 202 including the motor 214 and the motor 216.

Existing standards, such as those published by the 3^{rd} Generation Partnership Project (3GPP, which is a trademark of the European Telecommunications Standards Institute) do not provide a recommendation to avoid the noted issues related to excessive power drain in UAV devices. In extreme cases, however, exhaustion of the UAV battery 210 may yield to catastrophic results for the UAV 202 and data communication using the UAV 202.

FIG. 2B depicts an illustrative embodiment of a method 250 in accordance with various aspects described herein. The method 250 in embodiments operates to preserve battery power for aerial user terminals such as UAV 202 (FIG. 2A) operating over a radio communication network including, for example, multicarrier terrestrial 5G networks as illustrated in FIG. 2A. The method, in embodiments, implements data management and uplink power control. The method 250 operates to contrast or balance UAV traffic requirements against a number of operational factors to maximize battery life. The operational requirements may include, for example, current remaining battery power in the battery that powers the UAV, actual power control requirements per component carrier, and a number of available component carriers for transmission.

In one aspect, the method 250 relies on and builds up conventional transmit power control operations and standards. For example, standards published by 3GPP define two different types of UE uplink power control. These include open loop power control and closed loop power control. In open loop Power control (OLPC), a UE determines its transmission power based on its own power setting algorithm. This power setting algorithm takes in many inputs. Such inputs include, for example, UE internal setting and UE measurements. There is no feedback input from an eNodeB, gNodeB or other network element.

A closed loop power control (CLPC) operation uses a similar same operation employed by OLPC to determine the initial power that UE needs to communicate with the eNodeB or gNodeB. The same or similar inputs are used for the algorithm to establish an initial power setting for the UE. Subsequently, UE transmission power is controlled dynamically by feedback input provided to the UE from the eNodeB or gNodeB to which the UE is attached. Such eNodeB or gNodeB feedback is known as transmission power control (TPC) commands.

In general, UE transmission power changes dynamically based on multiple factors. Such factors include an assigned modulation and coding scheme (MCS). The MCS determines how information is encoded and modulated on a carrier. Higher order modulation such as 256 quadrature amplitude modulation (QAM) allows transmitting more data but requires better signal quality. For uplink power control, a UE assigned to poor MCS (such as quadrature phase shift keying or QPSK) may need higher transmit power than one assigned to good MCS (such as 64 QAM).

Another factor affecting UE transmission power is UE traffic demand. For example, a UE engaged in heavy traffic, such as a high definition (HD) video conference, may need higher transmit power than a UE engaged in relatively light traffic, such as a voice call.

Other factors affecting UE transmission power include network morphology and network design. Network morphology refers to physical and logic structure of the cellular network. Aspects include cell layout, including shape and size, cell density and cell overlap. Other aspects include deployment of different types of cells including microcells, small cells and macrocells. Other aspects include network interconnection, including backhaul and fronthaul connections. Still other aspects include spectrum allocation and antenna configuration. In an example, a UE located in an urban environment with many nearby and overlapping cells may require higher transmit power than one locate in a rural environment with fewer but more remote cells. Similarly, a UE located in a network with large inter-site distances may require higher TX power to reliably reach the base station.

Other factors affecting UE transmission power include power control and CLPC settings. Standards published by 3GPP define UE transmit power for the Physical Uplink Shared Channel (PUSCH). The PUSCH is the primary channel used by UEs to transmit data to a base station. The PUSCH transmit both user data and control data. The UE transmit power is defined as

$${P}_{PUSCH} = min \{ {P}_{max} , 10 \cdot {Log}_{10} M + {P}_{0} + ∝ * PL + {δ}_{m c s} + f ( {Δ}_{i} ) \} [ dBm ]$$

P_{PUSCH}: Power that the UE uses to transmit user data on the uplink channel.
Pₘₐₓ: Maximum allowed transmit power (23 dbm)
M: # of physical resource blocks (PRB) utilized to transmit UE data;
P₀: Cell/UE-specific parameter signaled by the radio resource control (RRC). Typical value of P₀=−90 dbm
∝: Path loss compensation factor. ∝ is in the range [0 1] and signaled by the RRC. Typical value of ∝=0.8
PL: Downlink path loss estimate by UE based on the measured and reported RSRP.
δ_{mcs}: a UE-specific MCS-dependent power offset. It reflects the different SINR requirements per MCS.
f(Δᵢ): UE specific, aka TPC. TPC (Transmit Power Control) is a closed loop correction value. It is used to compensate variations on the signal and interference powers in order to guarantee a desirable communication quality level.
Pₒ=∝*(SNRₒ+Pₙ)+(1−α)*(Pₘₐₓ−10·Log₁₀Mₒ) [dBm] Where;
SNRₒ is the is the open-loop target signal to noise ratio (SNR)
Pₙ is the noise power per PRB.
   Mₒ defines the number of PRBs for which the SNR target is reached with full power.

Other information used in the network for power control includes a power headroom report. An eNodeB or gNodeB uses the power headroom report (PHR) sent by the UE to estimate how much transmission power is left for a UE to use. In an example,

PHR=UE Max Transmission Power−PUSCH Power

PHR transmissions are sent by the UE periodically based on a timer.

Conventional power control operates to limit unnecessary battery drain and reduce interference in a radio network. Using both open loop power control and closed loop power control, a UE and the network cooperate to adjust uplink transmit power of the UE to a suitable level. When the UE is distant from a base station, the UE may be free to use maximum transmit power, or Pₘₐₓ. When the UE is physically closer to the base station, the transmit power is reduced through transmit power control techniques. This preserves the stored energy in the battery of the UE.

Method 250 illustrates a method for maximizing battery life for the battery of an aerial user terminal such as UAV 202, given requirements of applications running on the UAV. The method 250 may be part of an algorithm to monitor UAV battery based on actual readings of charge stored in the battery and to use prediction models to predict UAV battery drainage. The algorithm may estimate that the current usage rate of the energy in the UAV battery may result in exhaustion of the battery, meaning the battery no longer has sufficient stored charge to power radio components or electric motors of the UAV for propulsion. In some cases, the algorithm may set a minimum usage threshold for draining the battery. In an example, a minimum value of the state of charge of the battery may be set at 25% state of charge. State of charge (SOC) monitors are conventionally available to provide a reading of the current state of charge for a battery.

If the algorithm determines that the current uplink traffic demand will result in UAV battery exhaustion, the algorithm will estimate the amount of traffic demand that passes through each uplink component carrier (CC) and the corresponding power it is communicating. A component carrier corresponds to a portion of spectrum used for communication by the UAV. For example, 5G cellular systems enable carrier aggregation which allows devices such as the UAV to combine carrier signals from multiple frequency bands or carriers simultaneously. Each individual frequency band within this aggregation is called a component carrier. In typical examples, a UE may combine 4 or 8 carriers in a carrier aggregation transmission. Such carrier aggregation generally provides increased bandwidth, leading to faster data throughput and improved coverage. A similar example is dual technology transmission, in which a UE device such as a UE transmits one carrier in, for example, 4G LTE technology and one carrier in 5G technology.

Use of multiple carriers in this manner requires substantial power to drive multiple transmitters, including power amplifiers (PAs) for each component carrier. Thus, the algorithm estimates the amount of uplink traffic demand that passes through each component carrier as well as the corresponding power each component carrier requires for communication.

Based on these estimates, the algorithm may recommend one or more courses of action. First, the algorithm may recommend using conventional UE uplink power control mechanisms to fine-tune uplink transmit power at the carrier level. Each individual carrier may be adjusted based on factors such as frequency of transmission and distance from the UE to the base station. For example, the UAV uses four carriers for uplink communication and each carrier has a separate transmit power amplifier. The algorithm may recommend suitable transmit power levels for each carrier to preserve the UAV battery against depletion to the point of exhaustion while maintaining required performance characteristics such as data throughput, bit error rate or packet error rate.

In one example, the algorithm will determine and recommend a cap for the power level used for radio transmission by the UAV. For example, the transmission power may have a maximum value of, for example, Pₘₐₓ or the maximum allowed transmit power, which may be fixed at 23 dBm for handheld UEs. For aerial UEs such as the UAV 202, the maximum power Pₘₐₓ may be established at a much higher value by a standard or other practice. The value of P_{PUSCH} may be based on the value of Pₘₐₓ as indicated in the equation above. To cap the maximum power used by the UAV, the algorithm may set as a limit P_{PUSCH}<0.5*Pₘₐₓ. Any cap value may be chosen; 0.5 of the maximum power Pₘₐₓ is intended to be exemplary. Moreover, the value may be dynamically selected. An initial cap value of 0.5 may be selected. Subsequently, if the algorithm still determines that depletion of the battery is likely, the cap may be set to 0.4 or 0.25 of the value of Pₘₐₓ. The uplink shared channel power level P_{PUSCH} may then be reduced accordingly. Conventional closed loop power control operation may continue but with the new capped value for P_{PUSCH}.

Second, to further reduce transmit power, the algorithm may recommend disabling one or more uplink component carriers currently used by the UAV for transmission on the uplink. For example, if the UAV is operating in a carrier aggregation mode using 8 component carriers for data transmission, the UAV may disable four of the eight carriers to reduce power consumption in the UAV. The tradeoff for reduced power consumption may include a reduced data rate. Depending on the active application, that tradeoff may be acceptable. For example, if the UAV is uploading an HD video stream, the required data rate may demand usage of 8 component carriers. Falling back to 4 component carriers may unacceptably reduce the data rate so that a required quality of service (QoS) level cannot be maintained. QoS refers to performance characteristics of the network or service experience by network users. QoS relates to ensuring that different types of traffic receive the appropriate level of service or priority in the network based on their specific needs. For example, traffic associated with first responders will receive the highest priority QoS. Traffic associated with a file download may receive a lower priority QoS. The algorithm will assist in deciding a proper course of action, selecting between performance requirements and preserving charge in the UAV battery.

In some applications, the frequencies used by the different active component carriers may be different, they may have different amplifiers active in the transmit path, and they may have different data passing through the transmit path. One carrier may be transmitting a large amount of data at full channel power. This carrier, and the transmit path that transmits this carrier, will use more power than a lower power transmit path transmitting less data.

In a third example, the algorithm may recommend keying off or bypassing some transmission amplifiers if amplification is not needed. A disabled amplifier or component carrier remains energized and ready to transmit but is not actively selected for transmission. Its power consumption is reduced substantially by disabling. In contrast, when a transmit amplifier is keyed off, standby operating power is removed, and it is substantially powered down. The effect is to substantially reduce or eliminate the power consumption associated with that amplifier, but in the event the amplifier is needed again and is keyed up and reenergized, there may be a delay on the order of seconds before the amplifier is stable and operational and ready to transmit. Thus, the algorithm must decide the relative merits of eliminating power usage by keying off the transmitter versus the required key-up time when the transmitter becomes necessary again.

Some transmit paths may employ multiple transmit amplifiers. The amplifiers may be connected in parallel for selection of one amplifier that best matches a current transmission need. In the present example, one or more of the parallel amplifiers may be powered down or keyed off to eliminate the power drain it imposes on the battery. More powerful amplifiers, configured for long distance, high power transmissions, may provide the most power reduction if selected for keying off by the algorithm.

In a fourth example, the algorithm may recommend some combination of these transmit power reduction techniques. The algorithm operates to trade off uplink power demand required by active applications and other UAV operations with power consumption from the battery of the UAV.

Thus, in one example, the algorithm can calculate mathematically the amount of power being consumed at a particular moment, given the active circuits and data being transmitted. The algorithm can further determine how much charge is available from the battery. This determination can be either a real time measurement, such as a state of charge measurement, or an estimation based on modeling. By comparing the amount of charge available with current usage, the algorithm can estimate the likelihood of depletion of the battery. If depletion is likely, or if the likelihood of depletion exceeds a predetermined threshold such as 25% likely to exhaust the battery, the algorithm may begin implementing power saving measures by reducing transmit power usage.

In some examples, the algorithm may predict a future battery charge at a future time. Such a prediction may be made, for example, by an artificial intelligence (AI) or machine learning (ML) process. In examples, the predicted future battery charge may be based on predicted activities of the UAV. An example of such future activities is a known transmission that is to occur at a specified future time according to a schedule. Further, i n examples, the predicted future battery charge may be based on predicted conditions of the radio network, such as predicted interference levels that require higher transmission power or additional messaging with the network to control transmission power. Moreover, the process of predicting future battery charge may also improve the performance of the UAV. This may be done, for example, by maintaining enough battery charge to perform more important services. Further, the process of predicting future battery charge may also improve the performance of the network, or example, by providing better quality of service (QoS), avoiding inefficient network resource adjustments to accommodate a UAV that is low on battery charge, and which may be causing the network to provide priority treatment by network elements handling traffic to preserve the UAV power, for example.

Method 250 includes a model 252 which determines, for a UAV such as UAV 202, if current uplink transmission data demand exceeds available remaining charge in a battery that powers the UAV. The model 252 may include any suitable model or artificial intelligence component, including a machine learning model. The model 252 implements an algorithm as described for managing power control for uplink transmissions by the UAV. The model 252 may be implemented in any suitable location and by any suitable device or combination of devices. For example, the model 252 may be implemented at a base station in communication with the UAV. Alternatively, the model 252 may be implemented at the UAV. In still other examples, the model 252 may be implemented in part at a base station and in part at the UAV. Alternatively, the model may be implemented at any other network element, including at a network cloud computing element.

The model 252 receives a variety of inputs, as illustrated in FIG. 2B. For example, the model receives information about a transmission distance 254 between the UAs and a base station or gNodeB with which the UAV communicates. The transmission distance may be established in any suitable units, such as meters, between the current UAV location and the location of the base station. Further, the model 252 receives information about the available transmission bandwidth 256 for the UAV. The bandwidth may include carrier aggregation bandwidth portions that may be combined for transmission by the UAV.

Further inputs received by the model 252 include information about the amplifiers in use by the UAV. For example, the UAV may include multiple transmit paths, including respective amplifiers or power amplifiers in each transmit path. Moreover, each transmit path may include multiple available transmit amplifiers, including a relatively low power amplifier for shorter distances and a relatively higher power amplifier for transmission at longer distances. One or more transmit amplifiers may be selected depending on data transmission requirements and power consumption limitations.

Still further, the model 252 may receive information about the current transmission data demand placed on the UAV. For example, the UAV may be currently transmitting a 4K HD video live stream, which requires a substantial bandwidth for data transmission. In a further example, the information received by the model may include quality of service (QoS) values for data being currently transmitted.

In another example, the model 252 may receive information 262 about a number of transmit carriers. The transmit carriers correspond to component carriers that may be aggregated together. The information 262 may include information about the number of carriers available as well as the number of carriers currently in use. For example, for conveying the 4K HD video live stream, the UAV may currently be using 8 component carriers to provide adequate data throughput and QoS.

In a further example, the model 252 may receive information 264 about power control settings for each transmit carrier. For example, each carrier may have an individual maximum transmit power Pₘₐₓ that is based on the type of transmitter being used and other information. The information 264 about power control settings may be adjusted based on operation of the model 252 to manage uplink data demand for the UAV and remaining battery capacity for the UAV.

The model 252 may further receive information about the battery that powers the UAV. In one example, the model 252 receives a prediction 266 of remaining battery life for the battery. The prediction 266 of remaining battery life may be based on historical data 268 about battery usage. The historical data 268 about battery usage may include information about past experiences with battery charge levels, battery drain levels, environmental information such as ambient temperature and other conditions. The prediction 266 of battery life may be based on any suitable information, and may be generated by, for example, an artificial intelligence module or a machine learning model that uses the historical data 268 to develop the prediction of battery life. Further, the prediction 266 of battery life may be updated based on changing conditions and additional information as the information becomes available.

In addition, or alternatively, the model 252 may receive real time battery level information 270. The real time battery information 270 may be based on, for example, a measured state of charge value for the battery. The information about the battery level, including the prediction 266 of battery life, may be provided to the model 252 in any suitable manner. For example, where the model 252 is implemented at a base station or other infrastructure equipment, the information about the battery level may be transmitted as control information on the uplink from the UAV to the base station.

The model 252 receives the various input information and operates to determine operating conditions to maximize the battery life, or minimize current drain on the battery, in order to also satisfy data transmission requirements for the UAV and applications operating on the UAV. For example, the model 252 may determine that one or more component carriers should be disabled in order to reduce current drain and extend the life of the battery in order to fulfill data transmission requirements. In another example, the model 252 may determine that one or more transmit amplifiers should be keyed off in order to further reduce current demand and increase battery life. In another example, the model 252 may select a maximum power value of 50% or 40% of the value of Pₘₐₓ, and adjust power control implementation in that manner.

The model 252 determines if any corrective action should be taken. If so, at step 274, the selected corrective action is taken, and control returns to 276 to await updated data on operation of the UAV. If no correction corrective action is determined to be required, control proceeds to step 276 to await receipt of updated data.

In some aspects, the algorithm implemented by the model 252 may characterize the power control situation for the UAV and recommend steps to a user or the network to modify power control aspects to eliminate or reduce the risk of battery depletion. Alternatively, the algorithm may complete those operations to identify recommended corrective steps and, further, automatically adjust power control aspects of the network, the gNodeB and the UAV to reduce risk of battery depletion. The operation may be automatic and unsupervised and coordinated with other aspects of the network operation.

The proposed system thus provides an innovative approach to optimizing battery usage for unmanned aerial vehicles (UAVs) operating over mobility networks including multi-carrier terrestrial 5G networks. The disclosed system dynamically manages data and uplink power control based on UAV traffic requirements, battery levels, and power consumption predictions. By utilizing 3GPP-defined uplink power control mechanisms, the system adjusts transmission power according to factors such as distance and bandwidth needs, thereby conserving battery life. The system introduces an algorithm that monitors real-time battery levels and employs prediction models to anticipate battery drainage, allowing for necessary adjustments. The solution also proposes adaptive actions, such as fine-tuning uplink power at the carrier level, disabling certain uplink component carriers, and bypassing unnecessary uplink power amplifiers, all aimed at reducing power consumption and extending UAV operational time. This approach addresses the limitations of existing standards, which do not adequately prevent excessive power drain in UAVs, potentially leading to catastrophic outcomes.

An alternate embodiment of the subject matter of the disclosure incorporates artificial intelligence (AI) to further enhance the power management system. By integrating machine learning algorithms, the UAV system predicts battery drainage more accurately by analyzing historical data and real-time environmental conditions, such as wind speed and temperature, which affect battery performance. This AI-driven approach dynamically adjusts power settings and optimize flight paths to conserve energy.

Another embodiment involves the use of hybrid energy sources, such as solar panels integrated into the UAV's structure. This feature allows the UAV to harness solar energy during flight, reducing reliance on the onboard battery and extending operational time. The system may intelligently switch between battery and solar power based on real-time energy availability and consumption needs.

The system may also be adapted to support advanced communication protocols that prioritize energy efficiency. For instance, the UAV may employ low-power wide-area network (LPWAN) technologies for non-critical data transmissions, reserving high-power 5G connections for essential communications. This selective use of communication channels may further reduce battery consumption.

Additionally, the UAV may be designed with modular components, allowing for easy replacement or upgrading of parts such as batteries, transmitters, and amplifiers. This modularity enables the UAV to adapt to different mission requirements and technological advancements, ensuring optimal performance and energy efficiency.

In another embodiment, multiple UAVs operate as a collaborative network, sharing data and resources to optimize battery usage. For example, UAVs may cooperate to relay information through a mesh network, reducing the need for each UAV to maintain a direct high-power connection to a base station, thereby conserving energy. These alternate embodiments leverage the foundational concepts of the subject matter of the disclosure while introducing additional features and technologies to enhance battery optimization and operational efficiency in UAVs.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

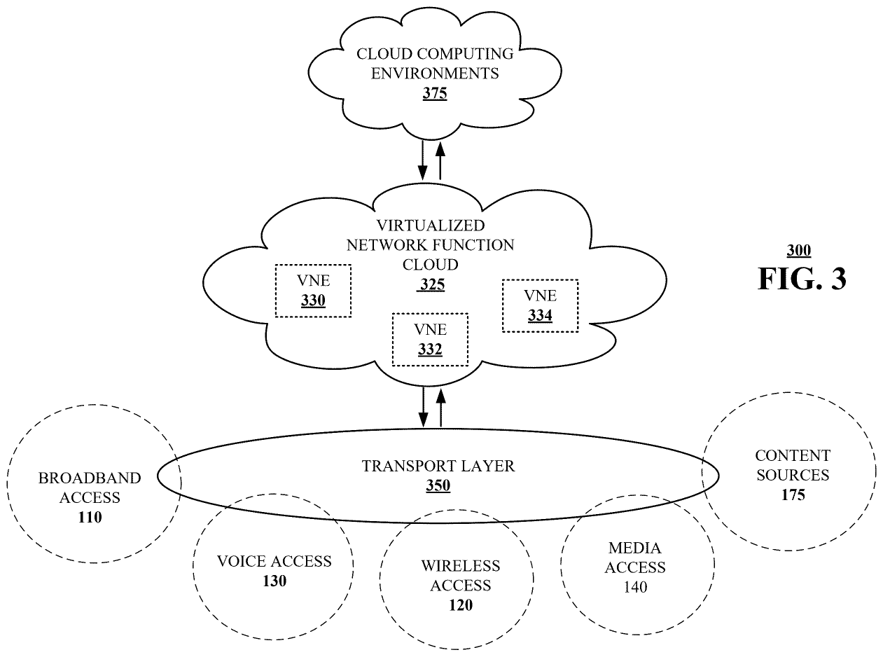

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, and method 250 presented in FIG. 1, FIG. 2A, FIG. 2B, and FIG. 3. For example, virtualized communication network 300 can facilitate in whole or in part optimizing battery usage in unmanned aerial vehicles (UAVs) operating over multi-carrier terrestrial 5G networks by dynamically managing data and uplink power control based on factors such as UAV traffic requirements, battery levels, and power consumption predictions.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

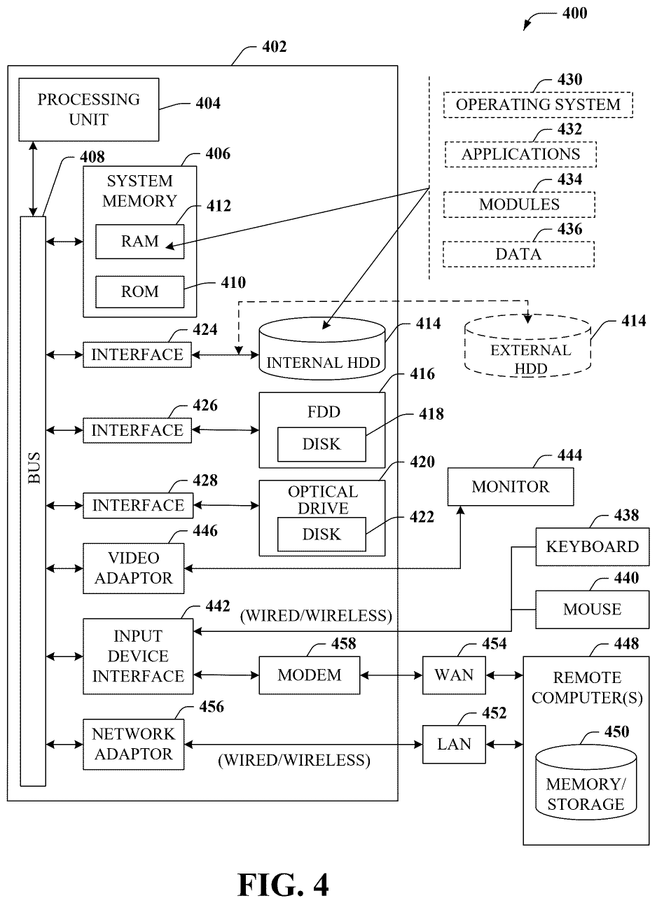

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part optimizing battery usage in unmanned aerial vehicles (UAVs) operating over multi-carrier terrestrial 5G networks by dynamically managing data and uplink power control based on factors such as UAV traffic requirements, battery levels, and power consumption predictions.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can also be connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

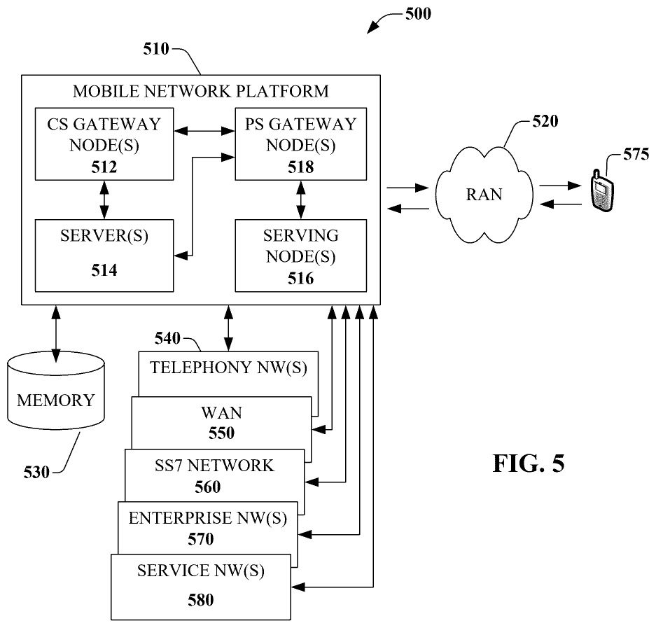

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part optimizing battery usage in unmanned aerial vehicles (UAVs) operating over multi-carrier terrestrial 5G networks by dynamically managing data and uplink power control based on factors such as UAV traffic requirements, battery levels, and power consumption predictions. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates substantially in the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

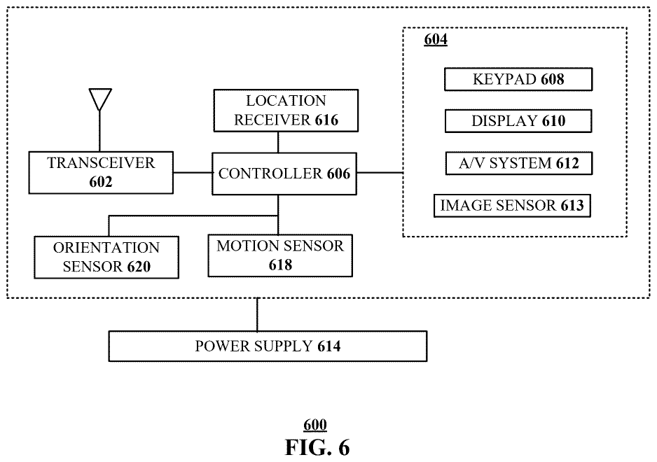

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part optimizing battery usage in unmanned aerial vehicles (UAVs) operating over multi-carrier terrestrial 5G networks by dynamically managing data and uplink power control based on factors such as UAV traffic requirements, battery levels, and power consumption predictions.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving, from an unmanned aerial vehicle (UAV) including radio communication circuitry and powered by a battery, battery charge information indicative of a remaining charge in the battery;
receiving information about radio communication by the radio communication circuitry, including receiving information about current uplink transmission demand by the radio communication circuitry with one or more terrestrial communication networks;
contrasting traffic requirements for the radio communication and the remaining charge in the battery to evaluate a likelihood of exhaustion of the battery;
recommending actions to optimize power consumption from the battery in order to extend operational time for the UAV; and
communicating, to the UAV over a terrestrial communication network, information to control the power consumption from the battery to reduce the likelihood of exhaustion of the battery.

2. The device of claim 1, wherein the communicating the information to control the power consumption from the battery comprises:
communicating uplink power control information to the UAV to adjust uplink transmit power of the UAV.

3. The device of claim 2, wherein the operations further comprise:
identifying a plurality of component carriers currently in use for uplink radio communication by the radio communication circuitry of the UAV;
estimating a respective amount of traffic carried on each respective component carrier of the plurality of component carriers;
estimating a respective amount of power consumed from the battery by each respective component carrier of the plurality of component carriers; and
determining an uplink power control adjustment for one or more component carriers of the plurality of component carriers to reduce an amount of power consumed by the battery by the one or more component carriers to thereby reduce the likelihood of exhaustion of the battery.

4. The device of claim 3, wherein the operations further comprise:
identifying one or more component carriers of the plurality of component carriers to disable; and
communicating information identifying the one or more component carriers to the UAV to reduce the amount of power consumed by the battery.

5. The device of claim 4, wherein the operations further comprise:
identifying one or more currently unnecessary amplifiers of the radio communication circuitry, forming identified amplifiers; and
communicating, to the UAV, information to key off the identified amplifiers to reduce the amount of power consumed by the battery.

6. The device of claim 1, wherein the receiving the battery charge information indicative of remaining charge in the battery comprises:
receiving current measurements of the remaining charge in the battery.

7. The device of claim 6, wherein the receiving the battery charge information indicative of remaining charge in the battery comprises:
receiving estimated battery charge information from a prediction model to anticipate battery drainage in the battery.

8. The device of claim 1, wherein the receiving the information about the radio communication by the radio communication circuitry comprises:
receiving information about transmission distances and transmission bandwidths in use by a plurality of transmission circuits of the radio communication circuitry; and
communicating, to the UAV, information to dynamically manage uplink power control for the radio communication circuitry based on power control mechanisms to adjust transmission power of the radio communication circuitry based on the transmission distances and the transmission bandwidths.

9. The device of claim 1, wherein the operations further comprise:
identifying power consumption on respective transmit paths of a plurality of transmit paths of the UAV, each respective transmit path in radio communication with a respective terrestrial communication network;
determining respective power control adjustments for each respective transmit path of the plurality of transmit paths of the UAV to reduce an amount of power consumed by the battery; and
communicating, to the UAV over a selected terrestrial communication network, information about the respective power control adjustments.

10. The device of claim 9, wherein the operations further comprise:
receiving updated battery charge information indicative of the remaining charge in the battery after implementation by the UAV of the respective power control adjustments;
evaluating a further likelihood of exhaustion of the battery following the implementation by the UAV of the respective power control adjustments; and
identifying further actions suitable to optimize power consumption from the battery in order to extend operational time for the UAV based on the updated battery charge information.

11. A non-transitory machine-readable medium, comprising executable instructions that, when executed by a processing system including a processor, facilitate performance of operations, the operations comprising:
receiving information about radio communication by an aerial user equipment operating in conjunction with one or more terrestrial radio networks, the radio communication including transmitting by radio circuitry of the aerial user equipment to one or more remote receivers on one or more respective uplinks;
receiving information about uplink traffic demand on the one or more respective uplinks;
receiving information about a remaining battery capacity of a battery system which powers the aerial user equipment;
determining, based on the uplink traffic demand and the remaining battery capacity of the battery system, adjustments to transmit power on the one or more respective uplinks, the adjustments to optimize power consumption from the battery system in order to extend operational time for the aerial user equipment; and
communicating, to the aerial user equipment, information about the adjustments to cause the radio circuitry of the aerial user equipment to reduce power consumption to extend the operational time for the aerial user equipment.

12. The non-transitory machine-readable medium of claim 11, wherein the receiving the information about the uplink traffic demand comprises:
receiving information about one or more applications active on the aerial user equipment; and
receiving information about transmission requirements of the one or more applications, including information about required transmission bandwidth, information about a number of component carriers used for transmission, information about a number of transmit amplifiers used for transmission, and transmission distance to a receiver of the one or more terrestrial radio networks.

13. The non-transitory machine-readable medium of claim 12, wherein the determining the adjustments to transmit power on the one or more respective uplinks comprises:
adjusting a respective transmit power level for each respective component carrier of the number of component carriers to reduce power consumption to extend the operational time for the aerial user equipment, wherein the adjusting the respective transmit power level relies on standardized uplink power control features of the one or more terrestrial radio networks.

14. The non-transitory machine-readable medium of claim 12, wherein the determining the adjustments to transmit power on the one or more respective uplinks comprises:
selecting one or more component carriers of the number of component carriers, forming selected component carriers; and
disabling the selected component carriers to reduce power consumption to extend the operational time for the aerial user equipment.

15. The non-transitory machine-readable medium of claim 12, wherein the determining the adjustments to transmit power on the one or more respective uplinks comprises:
based on the information about the number of transmit amplifiers used for transmission, selecting one or more transmit amplifiers for keying off to reduce power consumption to extend the operational time for the aerial user equipment, forming selected amplifiers; and
keying off the selected amplifiers.

16. A method, comprising:
adjusting, by a processing system including a processor, transmit power of one or more transmit paths in an aerial user equipment (UE), wherein the adjusting is based on uplink power control commands received at the aerial UE according to standardized uplink power control procedures for user equipment operating in conjunction with a terrestrial communication network;
determining, by the processing system, a current battery charge level of a battery system, the battery system providing operating power to the aerial UE;
reporting, by the processing system, the current battery charge level to network equipment, wherein the reporting comprises transmitting information about the current battery charge level over an uplink for the network equipment; and
receiving, by the processing system, power control adjustment information defining uplink power control adjustments to the transmit power of the one or more transmit paths of the aerial UE to reduce power consumption from the battery system of the UE to extend an operational time for the aerial user equipment.

17. The method of claim 16, comprising:
transmitting, by the processing system, to the network equipment over the uplink, information about a current uplink traffic demand for the aerial UE, including transmitting information about one or more applications active on the aerial user equipment; and
transmitting, by the processing system, to the network equipment over the uplink, information about transmission requirements of the one or more applications, including information about required transmission bandwidth, information about a number of component carriers used for transmission, information about a number of transmit amplifiers used for transmission, and transmission distance to a receiver of the terrestrial communication network.

18. The method of claim 16, comprising:
receiving, by the processing system, component carrier power control information; and
adjusting, by the processing system, based on the component carrier power control information, respective transmit power levels for one or more respective component carriers to reduce the power consumption from the battery system of the UE.

19. The method of claim 16, comprising:
receiving, by the processing system, transmit amplifier power control information; and
keying off, by the processing system, based on the transmit amplifier power control information, one or more transmit amplifiers of the aerial UE to reduce the power consumption from the battery system of the UE.

20. The method of claim 16, further comprising:
retrieving, by the processing system, historical data about battery usage by the battery system of the aerial UE;
predicting, by the processing system, a remaining life for the battery system, wherein the predicting the remaining life is based on the historical data about battery usage; and
reporting, by the processing system, the remaining life for the battery system to the network equipment.
